(19) United States
(12) Patent Application Publication
(10) Pub. No.: US 2026/0238334 A1
(43) Pub. Date: Aug. 13, 2026

(54) METHOD, APPARATUS AND DEVICE FOR GENERATING RESOURCE ALLOCATION STRATEGY BASED ON SATELLITE EDGE COMPUTING

(71) Applicant: Guangdong University of Technology, Guangzhou (CN)

(72) Inventor: Yi Liu, Guangzhou (CN)

(21) Appl. No.: 19/428,694

(22) Filed: Dec. 22, 2025

(30) Foreign Application Priority Data
Feb. 11, 2025 (CN) 202510150689.4

(51) Int. Cl. H04B 7/185; G06N 7/01

(52) U.S. Cl. CPC H04B 7/18539; G06N 7/01

(57) ABSTRACT

A method, apparatus and device for generating a resource allocation strategy based on satellite edge computing are provided, and applied to a satellite-terrestrial hybrid edge computing system. The method includes: calculating, based on an offloading decision parameter, a signal-to-noise ratio, a decoding rate, a transmitted data amount, a data transmission energy consumption, a time-slot computing task amount and a time-slot computing energy consumption for signal transmission between a satellite and each user terminal; calculating, based on the data transmission energy consumption and the time-slot computing energy consumption, a time-slot total energy consumption, and constructing an average energy consumption objective function; constructing a target optimization model by using a Lyapunov algorithm, combining the average energy consumption objective function and the multiple decision constraint conditions; and performing, based on a Markov decision process and an SCA algorithm, hierarchical decision solving on the target optimization model to obtain a target resource allocation strategy.

### CROSS-REFERENCE TO RELATED APPLICATION

This application claims priority to Chinese Patent Application No. 202510150689.4, filed on Feb. 11, 2025, which is herein incorporated by reference in its entirety.

### TECHNICAL FIELD

The disclosure relates to the field of distributed computing technologies, and more particularly to a method, apparatus and device for generating a resource allocation strategy based on satellite edge computing.

### BACKGROUND

Although some connected devices are equipped with powerful central processors, they still cannot meet the processing demands of computation-intensive tasks. Therefore, efficiently utilizing computing resources has become a significant challenge in contemporary network technology. Cloud computing is a centralized computing model, which provides crucial support for connected devices through its formidable computing power and on-demand resource provisioning. However, the cloud computing paradigm also suffers from drawbacks such as high latency, high energy consumption, data security risks, and inadequate user experience. Consequently, an extended computing model of the cloud computing-edge computing (EC) has been proposed.

Edge computing sinks the computing resources to a network edge, which is closer to the user-side, thereby significantly reducing transmission latency and energy consumption, and enhancing service quality. Due to a limited coverage of terrestrial edge computing and its susceptibility to disaster damage, low earth orbit (LEO) satellites and satellite-borne edge computing offer greater advantages. The LEO satellites and the satellite-borne edge computing can seamlessly cover user terminals over larger areas, and a distributed processing of data on satellite edge servers makes information distribution more dispersed, thereby increasing the difficulty of attacks. Furthermore, collaborative work between the satellites and ground stations are achieved, thereby achieving dynamic task allocation.

However, current LEO satellite edge computing still has shortcomings. For example, task scheduling and resource allocation are handled independently without considering the coupling effects between them, thereby leading to suboptimal overall system performance and insufficient resource utilization. Moreover, heterogeneous characteristics such as communication conditions among the user terminals are often not considered, thereby resulting in less objective and reliable resource allocation. Additionally, most related art optimize for a single objective, which inevitably overlooks other system performance metrics, which causes the overall system resource allocation to lack accuracy. Furthermore, current technologies often cannot adapt to complex scenarios where both communication link states and resource allocation are dynamic. Thus, their application is limited and struggles to meet practical demands.

### SUMMARY

The disclosure provides a method, apparatus and device for generating a resource allocation strategy based on satellite edge computing, to solve technical problems in the related art that actual resource allocation lacks accuracy, reliability, and applicability due to the failure to comprehensively consider factors such as task scheduling, resource allocation, communication link status, user heterogeneity, and multiple system performance indicators.

In view of this, a first aspect of the disclosure provides a method for generating a resource allocation strategy based on satellite edge computing, applied to a satellite-terrestrial hybrid edge computing system, including:
determining, based on a communication resource allocation strategy and a task offloading strategy, a decision for a computing task of each user terminal to obtain an offloading decision parameter;
calculating, based on the offloading decision parameter, a signal-to-noise ratio, a decoding rate, a transmitted data amount, and a data transmission energy consumption for signal transmission between a satellite and each user terminal;
calculating, based on the offloading decision parameter and an actual computing capability, a time-slot computing task amount and a time-slot computing energy consumption for each user terminal and the satellite individually, where the actual computing capability includes a user computing capability and a satellite computing capability;
calculating, based on the data transmission energy consumption and the time-slot computing energy consumption, a time-slot total energy consumption, and constructing, based on the time-slot total energy consumption, an average energy consumption objective function;
constructing, based on the offloading decision parameter, the actual computing capability, a queue dynamic evolution state, a queue task discard amount, a data transmission power, and a decoding ordering variable, multiple decision constraint conditions;
constructing an initial queue energy consumption optimization model by combining the average energy consumption objective function and the multiple decision constraint conditions, and simplifying, by using a Lyapunov algorithm, the initial queue energy consumption optimization model to obtain a target optimization model; and
performing, based on a Markov decision process and a successive convex approximation (SCA) algorithm, hierarchical decision solving on the target optimization model to obtain a target resource allocation strategy.

In an exemplary embodiment, the target resource allocation strategy includes an offloading strategy, a transmission power allocation strategy, decoding strategy and a computing resource allocation strategy, and the method further includes:
configuring, based on the target resource allocation strategy, computing resources in the satellite-terrestrial hybrid edge computing system to control at least one of the user terminals and the satellite to collaboratively execute the computing task, comprising:
   controlling, based on the offloading strategy and the transmission power allocation strategy, at least one of the user terminals to transmit message flows of the computing task to the satellite; and
   controlling, based on the decoding strategy and the computing resource allocation strategy, the satellite to decode the received message flows and perform edge computing processing.

In an embodiment, before the determining, based on a communication resource allocation strategy and a task offloading strategy, a decision for a computing task of each user terminal to obtain an offloading decision parameter, the method further includes:
formulating, based on mobility of the user terminals, a task demand amount, and a link state, the communication resource allocation strategy, the task offloading strategy, and a computing resource allocation strategy dynamically.

In an embodiment, the calculating, based on the offloading decision parameter, a signal-to-noise ratio, a decoding rate, a transmitted data amount, and a data transmission energy consumption for signal transmission between a satellite and each user terminal includes:
calculating, based on the offloading decision parameter, a channel model, and the data transmission power, a signal-to-noise ratio for each signal transmitted from each user terminals to the satellite;
calculating, based on the signal-to-noise ratio and a total system bandwidth, the decoding rate for each message flow;
calculating, based on the decoding rate and a task transmission time, the transmitted data amount for each message flow; and
calculating a time-slot transmission energy consumption of each user terminal by combining the offloading decision parameter and the data transmission power to obtain the data transmission energy consumption.

In an embodiment, the calculating, based on the offloading decision parameter, a signal-to-noise ratio, a decoding rate, a transmitted data amount, and a data transmission energy consumption for signal transmission between a satellite and each user terminal further includes:
transmitting, by using a rate-splitting multiple access (RSMA) technology and based on the transmitted data amount and the data transmission energy consumption, the message flows of the user terminals to the satellite for computation; and
decoding the message flows and allocating the computing resources by the satellite and based on a successive interference cancellation (SIC) technology and a computing resource allocation strategy.

In an embodiment, the calculating, based on the offloading decision parameter and an actual computing capability, a time-slot computing task amount and a time-slot computing energy consumption for each user terminal and the satellite individually includes:
calculating, based on the offloading decision parameter and the user computing capability, a computing task amount of each user terminal to obtain a user computing task amount;
calculating, based on the offloading decision parameter, the user computing capability, and a transmission computing time, a computing energy consumption of each user terminal to obtain a user computing energy consumption;
calculating, based on the satellite computing capability and a satellite processing density, a computing task amount of the satellite to obtain a satellite computing task amount; and
calculating, based on the satellite computing capability and a satellite computing time, a computing energy consumption of the satellite to obtain a satellite computing energy consumption;
where the user computing task amount and the satellite computing task amount constitute the time-slot computing task amount; and
where the user computing energy consumption and the satellite computing energy consumption constitute the time-slot computing energy consumption.

In an embodiment, before the constructing, based on the offloading decision parameter, the actual computing capability, a queue dynamic evolution state, a queue task discard amount, a data transmission power, and a decoding ordering variable, multiple decision constraint conditions, the method further includes:
calculating, based on the transmitted data amount, the time-slot computing task amount, and a time-slot task arrival amount, a user dynamic evolution state of a user terminal queue;
calculating, based on the user dynamic evolution state, the time-slot task arrival amount, and a user queue upper limit value, a user task discard amount of the user terminal queue;
calculating, based on the transmitted data amount and the time-slot computing task amount, a satellite dynamic evolution state of a satellite queue; and
calculating, based on the satellite dynamic evolution state, the transmitted data amount, and a satellite queue upper limit value, a satellite task discard amount of the satellite queue;
where the user dynamic evolution state and the satellite dynamic evolution state constitute the queue dynamic evolution state; and
where the user task discard amount and the satellite task discard amount constitute the queue task discard amount.

In an embodiment, the constructing an initial queue energy consumption optimization model by combining the average energy consumption objective function and the multiple decision constraint conditions, and simplifying, by using a Lyapunov algorithm, the initial queue energy consumption optimization model to obtain a target optimization model includes:
constructing the initial queue energy consumption optimization model by combining the average energy consumption objective function and the plurality of decision constraint conditions;
defining, based on the queue task discard amount, a virtual packet loss queue;
defining, by using the Lyapunov algorithm and based on the virtual packet loss queue and the queue dynamic evolution state, a Lyapunov function;
defining, based on the Lyapunov function, the time-slot total energy consumption, and an energy consumption weight parameter, a drift-plus-penalty term; and
performing a minimization optimization on the drift-plus-penalty term through a defined queue stability cost function, and simplifying the initial queue energy consumption optimization model to the target optimization model.

In an embodiment, the performing, based on a Markov decision process and an SCA algorithm, hierarchical decision solving on the target optimization model to obtain a target resource allocation strategy includes:
dividing, based on a hierarchical reinforcement learning method guided by the Lyapunov algorithm, the target optimization model into an upper-layer optimization model and a lower-layer optimization model;
defining, based on the Markov decision process and the upper-layer optimization model, a global queue state space, a global queue action space, and a global queue reward function to obtain an upper-layer queue stability decision model;
performing, by using an extended SCA algorithm, an optimization solution on the upper-layer queue stability decision model to obtain an offloading strategy, a transmission power allocation strategy, and a decoding strategy;
defining, based on the Markov decision process and the lower-layer optimization model, a local queue state space, a local queue action space, and a local queue reward function to obtain a lower-layer queue stability decision model; and
performing, by using a standard SCA algorithm, an optimization solution on the lower-layer queue stability decision model to obtain a computing resource allocation strategy, wherein the computing resource allocation strategy includes a user computing resource allocation strategy and a satellite computing resource allocation strategy; and
where the target resource allocation strategy includes the offloading strategy, the transmission power allocation strategy, the decoding strategy, and the computing resource allocation strategy.

A second aspect of the disclosure provides an apparatus for generating a resource allocation strategy based on satellite edge computing, applied to a satellite-terrestrial hybrid edge computing system, and the apparatus includes an offloading decision determination unit, a transmission parameter calculation unit, a task processing analysis unit, an energy consumption objective construction unit, a constraint condition construction unit, a model optimization construction unit, and a model optimization solving unit.

The offloading decision determination unit is configured to determine, based on a communication resource allocation strategy and a task offloading strategy, a decision for a computing task of each user terminal to obtain an offloading decision parameter.

The transmission parameter calculation unit is configured to calculate, based on the offloading decision parameter, a signal-to-noise ratio, a decoding rate, a transmitted data amount, and a data transmission energy consumption for signal transmission between a satellite and each user terminal.

The task processing analysis unit is configured to calculate, based on the offloading decision parameter and an actual computing capability, a time-slot computing task amount and a time-slot computing energy consumption for each user terminal and the satellite individually, wherein the actual computing capability comprises a user computing capability and a satellite computing capability.

The energy consumption objective construction unit is configured to calculate, based on the data transmission energy consumption and the time-slot computing energy consumption, a time-slot total energy consumption, and to construct, based on the time-slot total energy consumption, an average energy consumption objective function.

The constraint condition construction unit is configured to construct, based on the offloading decision parameter, the actual computing capability, a queue dynamic evolution state, a queue task discard amount, a data transmission power, and a decoding ordering variable, multiple decision constraint conditions.

The model optimization construction unit is configured to construct an initial queue energy consumption optimization model by combining the average energy consumption objective function and the multiple decision constraint conditions, and simplify, by using a Lyapunov algorithm, the initial queue energy consumption optimization model to obtain a target optimization model.

The model optimization solving unit is configured to perform, based on a Markov decision process and an SCA algorithm, hierarchical decision solving on the target optimization model to obtain a target resource allocation strategy.

In an exemplary embodiment, each of the offloading decision determination unit, the transmission parameter calculation unit, the task processing analysis unit, the energy consumption objective construction unit, the constraint condition construction unit, the model optimization construction unit, and the model optimization solving unit is embodied by at least one processor and at least one memory coupled to the at least one processor, and the at least one memory stores computer programs executable by the at least one processor.

A third aspect of the disclosure provides a device for generating a resource allocation strategy based on satellite edge computing, and the device includes a processor and a memory.

The memory is configured to store program codes and transmit the program codes to the processor.

The processor is configured to execute, based on instructions in the program codes, the method for generating the resource allocation strategy based on satellite edge computing as described in the first aspect.

It can be seen from the above technical solutions that the embodiments of the disclosure has the following advantages.

In the disclosure, a method for generating a resource allocation strategy based on satellite edge computing is provided, which is applied to the satellite-terrestrial hybrid edge computing system. The method includes: determining, based on the communication resource allocation strategy and the task offloading strategy, the decision for the computing task of each user terminal to obtain the offloading decision parameter; calculating, based on the offloading decision parameter, the signal-to-noise ratio, the decoding rate, the transmitted data amount, and the data transmission energy consumption for signal transmission between the satellite and each user terminal; calculating, based on the offloading decision parameter and the actual computing capability, the time-slot computing task amount and the time-slot computing energy consumption for each user terminal and the satellite individually, wherein the actual computing capability includes the user computing capability and the satellite computing capability; calculating, based on the data transmission energy consumption and the time-slot computing energy consumption, the time-slot total energy consumption, and constructing, based on the time-slot total energy consumption, the average energy consumption objective function; constructing, based on the offloading decision parameter, the actual computing capability, the queue dynamic evolution state, the queue task discard amount, the data transmission power, and the decoding ordering variable, the multiple decision constraint conditions; constructing the initial queue energy consumption optimization model by combining the average energy consumption objective function and the multiple decision constraint conditions, and simplifying, by using the Lyapunov algorithm, the initial queue energy consumption optimization model to obtain the target optimization model; and performing, based on the Markov decision process and the SCA algorithm, the hierarchical decision solving on the target optimization model to obtain the target resource allocation strategy.

The method for generating the resource allocation strategy based on satellite edge computing provided in the disclosure not only determines whether a computing task should be computed locally or offloaded to the satellite for edge computing based on the offloading decision parameter, but also calculates transmission parameters such as the signal-to-noise ratio for signals transmitted from the user terminal. This process fully considers the heterogeneous characteristics of the user terminals, which makes resource allocation operations based on this more aligned with real-world conditions. Furthermore, by calculating the time-slot total energy consumption resulting from task scheduling while considering various performance parameters of the user terminals and the satellite, and constructing the average energy consumption objective function based on this, the issue of system energy consumption optimization is addressed. Configuring decision constraint conditions based on parameters such as the queue dynamic evolution state and the task discard amount fully considers the queue stability optimization problem. Configuring decision constraint conditions based on the actual computing capabilities, the data transmission power, and the decoding ordering variables takes into account the time-varying characteristics of dynamic communication link changes and resource allocation. Moreover, the process of optimizing and subsequently solving the model by using the Lyapunov algorithm ensures that each optimization objective reaches its optimal solution while also adapting to various data formats within the target optimization model. It can also perform optimization solving for multi-stage optimization problems involving dynamically changing link states and resource allocation, adapting to complex scenario changes. The entire process comprehensively considers multiple situations, various parameters, and the interactions among multiple optimization objectives within the edge computing system, thereby enabling the generation of accurate and reliable resource allocation strategies with strong applicability. Therefore, the disclosure can solve the technical problem in the related art where actual resource allocation lacks accuracy, reliability, and applicability due to the failure to comprehensively consider factors such as task scheduling, resource allocation, communication link status, user heterogeneity, and multiple system performance indicators.

### BRIEF DESCRIPTION OF DRAWINGS

FIG. 1 illustrates a flowchart of a method for generating a resource allocation strategy based on satellite edge computing according to an embodiment of the disclosure.

FIG. 2 illustrates a schematic structural diagram of an apparatus for generating a resource allocation strategy based on satellite edge computing according to an embodiment of the disclosure.

FIG. 3 illustrates a schematic structural diagram of a satellite-terrestrial hybrid edge computing system according to an embodiment of the disclosure.

FIG. 4 illustrates a schematic diagram of satellite-terrestrial transmission signal flows at time slot according to an embodiment of the disclosure.

FIG. 5 illustrates a schematic diagram of layer information obtained by dividing a target optimization model by using a Lyapunov algorithm according to an embodiment of the disclosure.

### DETAILED DESCRIPTION OF EMBODIMENTS

In order to enable those skilled in the art to better understand solutions of the disclosure, the following will clearly and completely describe technical solutions in embodiments of the disclosure with reference to drawings in the embodiments. Apparently, the described embodiments are merely some of the embodiments of the disclosure, and not all of the embodiments. Based on the embodiments in the disclosure, all other embodiments obtained by those skilled in the art without making creative efforts shall fall within a protection scope of the disclosure.

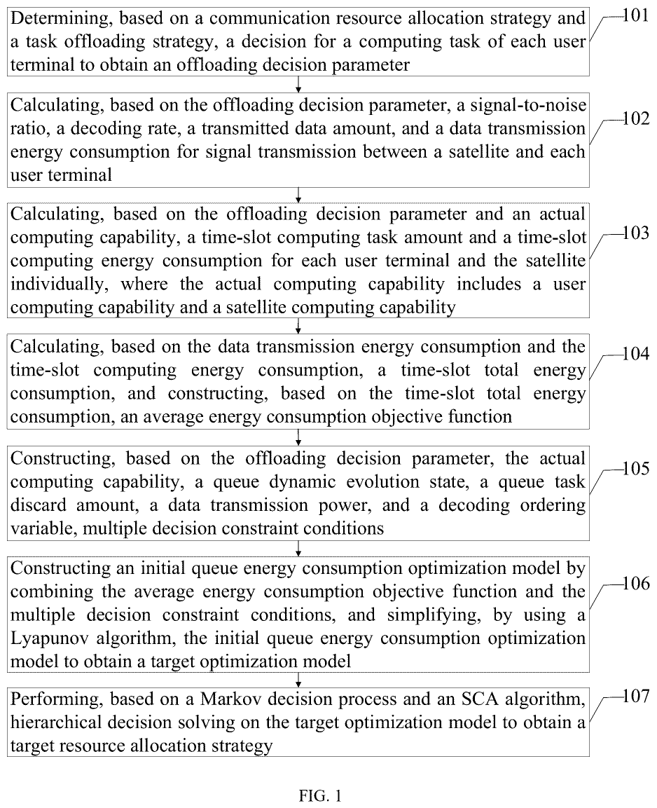

For ease of understanding, please refer to FIG. 1, the disclosure provides a method for generating a resource allocation strategy based on satellite edge computing, applied to a satellite-terrestrial hybrid edge computing system, and the method includes the following steps 101-107.

In step 101, a decision for a computing task of each user terminal is determined based on a communication resource allocation strategy and a task offloading strategy, to obtain an offloading decision parameter.

In an embodiment, before the step 101, the method further includes the following steps.

The communication resource allocation strategy, the task offloading strategy, and a computing resource allocation strategy are dynamically formulated based on mobility of each user terminal, a task demand amount, and a link state.

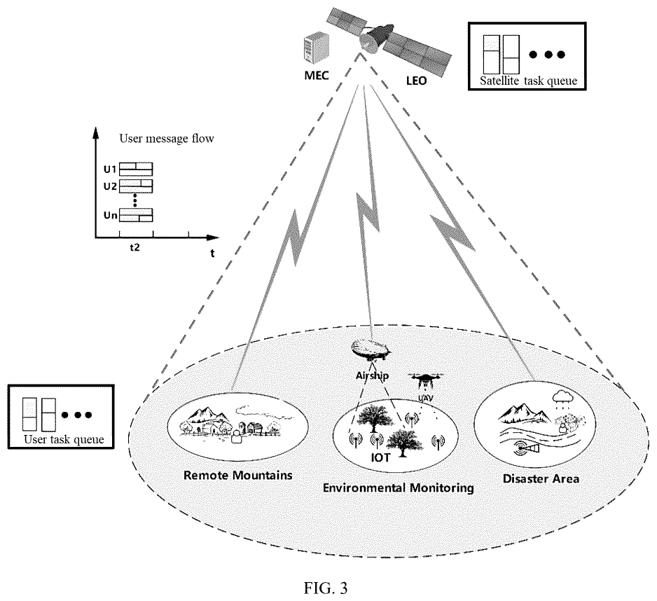

It should be noted that the method for generating the resource allocation strategy is applied to the satellite-terrestrial hybrid edge computing system proposed in the embodiment. The satellite-terrestrial hybrid edge computing system combines resources of LEO satellites and ground networks to enhance resource utilization and service quality through collaborative work. Specifically, please refer to FIG. 3, the satellite-terrestrial hybrid edge computing system includes a LEO satellite and N terrestrial user terminal groups GU. The LEO satellite serves as a satellite-borne edge computing node, which deploys an edge computing multi-access edge computing (MEC) server for processing computing tasks and providing communication services. The terrestrial user terminal groups orthogonally occupy N resource blocks NB, and all users within a group share the same resource block. Due to the heterogeneity and mobility of the user terminals and the randomness of task arrival amounts, the system exhibits dynamic time-varying characteristics in communication link states and resource allocation.

The system provided by the embodiment operates in a time-slotted manner, with a time expressed as t∈{1, 2, . . . , T−1} and a time slot of τ. A working process of the system can be divided into four stages. In the first stage t₁, the system dynamically formulates the communication resource allocation strategy, the task offloading strategy, and the computing resource allocation strategy based on mobility of the user terminals, the task demand amount, and the link state. In the second stage t₂, the user terminals can transmit and process computing tasks according to the communication resource allocation strategy and the task offloading strategy formulated by the system. The computing tasks can be chosen to be transmitted to the LEO satellite or computed directly on a local device, thereby generating the offloading decision parameter α_{n,i}(t). In the third stage t₃, the LEO satellite and the user terminals allocate computing resources to each user according to the computing resource allocation strategy. In the fourth stage t₄, the LEO satellite returns the computation results to devices of the user terminals. Since a volume of computation results is much smaller than original task data, the time for this stage can be ignored. Moreover, since t₁ and t₄ are much smaller than t₂ and t₃, the case where t₂+t₃≤τ does not need to be considered. The above offloading decision parameter α_{n,i}(t) represents a parameter for an i^{th} user terminal in a n^{th} terrestrial user terminal group. The number of the terrestrial user terminal groups is expressed as {1, 2, . . . , N}, each terrestrial user terminal group includes multiple user terminals, which is expressed as {1, 2, . . . , Iₙ}. A user's computing task message can be divided into {1, 2, . . . , J} message flows for transmission. The offloading decision parameter α_{n,i}(t) is expressed as follows:

$${α}_{n , i} ( t ) \{ \begin{matrix}0 & local computation \\ 1 & satellite computation\end{matrix} .$$

In step 102, a signal-to-noise ratio, a decoding rate, a transmitted data amount, and a data transmission energy consumption for signal transmission between the satellite and each user terminal are calculated based on the offloading decision parameter.

In an embodiment, the step 102 includes the following steps.

A signal-to-noise ratio for each signal transmitted from each user terminal to the satellite is calculated based on the offloading decision parameter, a channel model, and the data transmission power.

The decoding rate for each message flow is calculated based on the signal-to-noise ratio and a total system bandwidth.

The transmitted data amount for each message flow is calculated based on the decoding rate and a task transmission time.

A time-slot transmission energy consumption of each user terminal is calculated by combining the offloading decision parameter and the data transmission power to obtain the data transmission energy consumption.

In an embodiment, the step 102 further includes the following steps.

The message flows of the user terminals are transmitted to the satellite for computation by using a RSMA technology and based on the transmitted data amount and the data transmission energy consumption.

The message flows are decoded and the computing resources are allocated by the satellite and based on a SIC technology and a computing resource allocation strategy.

It should be noted that to alleviate transmission interference among multiple different user terminals and improve frequency utilization and system capacity, the embodiment selects the RSMA technology to implement information transmission from users to the satellite. The user terminals are configured with a single antenna and utilize the RSMA technology at a physical layer to segment and decode {1, 2, . . . , J} message flows, which transmits information by sharing the same spectrum resources, thereby alleviating transmission interference among users and improving spectrum utilization.

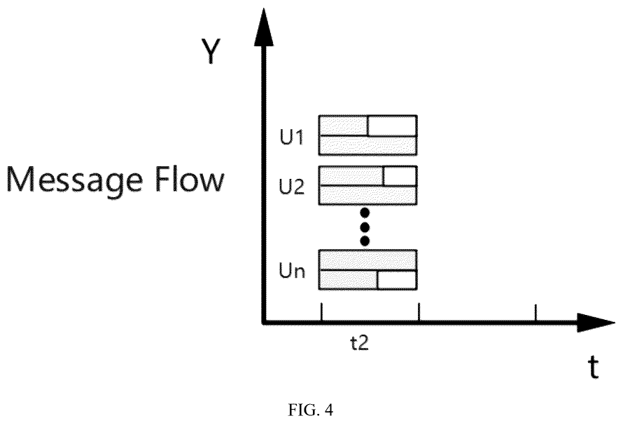

Please refer to FIG. 4, if a transmitted signal of the i^{th} user terminal U_{n,i} in the n^{th} terrestrial user terminal group is expressed as follows:

$${x}_{n , i} ( t ) = {\sum }_{j = 1}^{J} \sqrt{{p}_{n , i , j} ( t )} {x}_{n , i , j} ( t ) ;$$

where p_{n,i,j}(t) represents a data transmission power allocated by the user terminal U_{n,i} to a message flow j, x_{n,i,j}(t) represents a transmitted signal corresponding to the message flow j.

If a signal received by the LEO satellite is expressed as follows:

$${y}_{n} ( t ) = {\sum }_{i = 1}^{{I}_{n}} {g}_{n , i} ( t ) {x}_{n , i} ( t ) + {N}_{0} ;$$

where N₀ represents an additive white Gaussian noise, and g_{n,i}(t) represents the channel model, which can be expressed as follows:

$${g}_{n , i} ( t ) = \sqrt{{G}_{s} {G}_{n}} {v}_{n , i} {r}_{n , i} ε {d}_{n , i}^{- β} ( t ) ;$$

where Gₛ represents an antenna gain of the LEO satellite, Gₙ represents an antenna gain of the user terminals, v_{n,i} represents a Rayleigh fading of a complex Gaussian variable, r_{n,i} represents a log-normally distributed shadow attenuation, E represents a unit path loss constant,

$${d}_{n , i}^{- β} ( t )$$

represents a path attenuation, β represents a path loss exponent, and d_{n,i}(t) represents a distance from each user terminal to the LEO satellite in each time slot.

The LEO satellite decodes the received signal by using the SIC technology and can then allocate the computing resources to the received computing tasks according to the computing resource allocation strategy. Specifically, the LEO satellite prioritizes decoding a specific message flow based on a specific decoding strategy while treating other undecoded message flows as interference. Then, the influence of the currently decoded message flow is removed from the received signal to reduce interference for subsequent decoding, and the remaining message flows are decoded sequentially. This decoding strategy can effectively improve communication efficiency and decoding accuracy in multi-user terminal scenarios. The decoding strategy is determined by the decoding ordering variable, i.e., the decoding sequence, which is expressed as πₙ(t)={π_{n,i,j}(t)}. If π_{n,i,j}<π_{n,k,s}, it means that signal flow x_{n,i,j} is decoded before x_{n,k,s}. Based on this, the signal-to-noise ratio (SINR) for each signal flow is expressed as follows:

$${SINR}_{n , i , j} ( t ) = \frac{{α}_{n , i} ( t ) {p}_{n , i , j} ( t ) {\vert {g}_{n , i} \vert}^{2}}{\begin{matrix}{\sum }_{{π}_{n , i , j} < {π}_{n , k , s}} {α}_{n , i} ( t ) {p}_{n , i , j} ( t ) {\vert {g}_{n , i} \vert}^{2} + \\ {\sum }_{{π}_{n , i , j} < {π}_{n , k ∈ {I}_{n} \backslash \{ i \} , s}} {α}_{n , k} ( t ) {p}_{n , k , j} ( t ) {\vert {g}_{n , k , s} \vert}^{2} + {Δ}^{2}\end{matrix}} ;$$

where Δ represents a variance of the additive white Gaussian noise, that is, noise power, α_{n,i}(t) is the offloading decision parameter, indicating whether the user chooses to keep the computing task for local computation or offload it to the LEO satellite. When α_{n,i}(t)=0, it indicates that the computing task is kept for local computation, and the SINR due to communication is 0, that is, SINR_{n,i,j}(t)=0. In this case, the user does not cause interference to the transmission operations of other user terminals; the interference is 0, which is expressed as follows:

$${\sum }_{j} {α}_{n , i} ( t ) {p}_{n , i , j} ( t ) {\vert {g}_{n , i} \vert}^{2} = 0 ;$$

when α_{n,i}(t)=1, it indicates that the computing task is offloaded to the LEO satellite for computation, and the SINR of the signal must satisfy the following condition to be correctly decoded:

$${SINR}_{n , i , j} ( t ) \geq {γ}_{th} ;$$

where γₜₕ represents a decoding threshold, which is a minimum SINR required in the system to successfully decode a signal; and when the received SINR is greater than or equal to the decoding threshold, the system can consider the signal correctly decoded.

Based on the above, the decoding rate for the message flow x_{n,i,j}(t) of the user terminal U_{n,i} can be calculated based on the SINR and a total system bandwidth as follows:

$${R}_{n , i , j} ( t ) = \frac{B}{N} {log}_{2} ( 1 + {SINR}_{n , i , j} ( t ) ) ;$$

where B represents a total available bandwidth of the system, that is, the total system bandwidth, N represents the number of the terrestrial user terminal groups, also the number of orthogonally shared resource blocks; and when the offloading decision parameter α_{n,i}(t)=0, SINR_{n,i,j}(t)=0, thus the decoding rate R_{n,i,j}(t)=0.

A total data decoding rate of the user terminal U_{n,i} can be expressed as follows:

$${R}_{n , i} ( t ) = {\sum }_{j = 1}^{J} {R}_{n , i , j} ( t ) .$$

Thus, the total transmission data amount can be expressed as follows:

$${D}_{n , i}^{u , tran} ( t ) = {t}_{2} {R}_{n , i} ( t ) ;$$

where t₂ represents a time for each user terminal to send the message flows to the LEO satellite, i.e., the task transmission time.

At this point, the time-slot transmission energy consumption of the user terminal U_{n,i} at a time slot t, i.e., the data transmission energy consumption, can be expressed as follows:

$${E}_{m , i}^{u , tran} ( t ) = {α}_{n , i} ( t ) {\sum }_{j = 1}^{J} {p}_{n , i , j} ( t ) {t}_{2} .$$

In step 103, a time-slot computing task amount and a time-slot computing energy consumption for each user terminal and the satellite are individually calculated based on the offloading decision parameter and an actual computing capability. The actual computing capability includes a user computing capability and a satellite computing capability.

In an embodiment, the step 103 further includes the following steps.

A computing task amount of each user terminal is calculated based on the offloading decision parameter and the user computing capability to obtain a user computing task amount.

A computing energy consumption of each user terminal is calculated based on the offloading decision parameter, the user computing capability, and a transmission computing time to obtain a user computing energy consumption.

A computing task amount of the satellite is calculated based on the satellite computing capability and a satellite processing density, to obtain a satellite computing task amount.

A computing energy consumption of the satellite is calculated based on the satellite computing capability and a satellite computing time, to obtain a satellite computing energy consumption.

The user computing task amount and the satellite computing task amount constitute the time-slot computing task amount.

The user computing energy consumption and the satellite computing energy consumption constitute the time-slot computing energy consumption.

It should be noted that the embodiment considers both local computation by the user and edge computation by the satellite. Therefore, the analysis must be divided into local computation mode and satellite edge computation mode. When the offloading decision parameter α_{n,i}(t)=0, the computing task of the user terminal U_{n,i} is computed locally. The actual computing capability allocated to the user is the user computing capability, a user computing capability at the time slot t is expressed as

$${f}_{n , i}^{u} ( t ) ,$$

with unit of cycles per second (cycles/s), and a maximum user computing capability is expressed as

$${f}_{n , i}^{u , max} .$$

The user computing task amount for the user terminal Un at the time slot t can then be expressed as follows:

$${D}_{n , i}^{u , comp} ( t ) = ( 1 - {α}_{n , i} ( t ) ) \frac{{f}_{n , i}^{u} ( t )}{{C}_{n , i}^{u}} ( {t}_{2} + {t}_{3} ) ;$$

where

$${C}_{n , i}^{u}$$

represents a processing density of a user's central processing unit (CPU), in cycles/bit, t₂ represents a decision transmission time for information, t₃ represents a local computation time consumed by the user, and a sum of t₂ and t₃ represents the transmission computation time for local processing; at this point, the user computing energy consumption for the user terminal U_{n,i} at the time slot t is expressed as follows:

$${E}_{n , i}^{u , comp} ( t ) = ( 1 - {α}_{n , i} ( t ) ) {{ε}_{n , i}^{u} ( {f}_{n , i}^{u} ( t ) )}^{3} ( {t}_{2} + {t}_{3} ) ;$$

where

$${ε}_{n , i}^{u}$$

represents an effective energy coefficient of the CPU of the user terminal U_{n,i}.

When α_{n,i}(t)=1, the computing task of the user terminal U_{n,i} is computed on the LEO satellite. Then, the satellite computing task amount processed by the LEO satellite at the time slot t is expressed as follows:

$${D}_{n , i}^{s , comp} ( t ) = \frac{{f}_{n , i}^{s} ( t )}{{C}_{n , i}^{s}} {t}_{3} ;$$

where

$${f}_{n , i}^{s} ( t )$$

represents the actual computing capability allocated by the LEO satellite to the user terminal U_{n,i}, that is, the satellite computing capability, with its maximum value expressed as

$${f}_{n , i}^{s , max} , {C}_{n , i}^{s}$$

represents a processing density of a CPU of the LEO satellite, that is, the satellite processing density.

At this point, the satellite computing energy consumption of the LEO satellite at the time slot t is expressed as follows:

$${E}_{n , i}^{u , comp} ( t ) = {{ε}_{n , i}^{s} ( {f}_{n , i}^{s} ( t ) )}^{3} {t}_{3} ;$$

where

$${ε}_{n , i}^{s}$$

represents an effective energy coefficient of the CPU of the LEO satellite.

In step 104, a time-slot total energy consumption is calculated based on the data transmission energy consumption and the time-slot computing energy consumption, and an average energy consumption objective function is constructed based on the time-slot total energy consumption.

The time-slot computing energy consumption includes the user computing energy consumption

$${E}_{n , i}^{u , comp} ( t )$$

and the satellite computing energy consumption

$${E}_{n , i}^{s , c o m p} ( t ) ,$$

the data transmission energy consumption is expressed as

$${E}_{n , i}^{u , tran} ( t ) ,$$

thus, the system's time-slot energy consumption for the user terminal U_{n,i} at the time slot t is expressed as follows:

$${E}_{n , i}^{total} ( t ) = {E}_{n , i}^{u , tran} ( t ) + {E}_{n , i}^{u , comp} ( t ) + {E}_{n , i}^{s , c o m p} ( t ) .$$

Then, the overall time-slot energy consumption of the system at the time slot t for the terrestrial user terminal group n is expressed as follows:

$${E}_{n}^{total} ( t ) = {\sum }_{i} {E}_{n , i}^{total} ( t ) .$$

Thus, the total time-slot energy consumption of the system at the time slot t can be expressed as follows:

$${E}^{total} ( t ) = {\sum }_{n} {E}_{n}^{total} ( t ) .$$

In order to enable subsequent joint optimization based on energy consumption optimization, the embodiment sets minimizing the long-term average total energy consumption of the system as the optimization objective, thereby constructing the average energy consumption objective function as follows:

$${min}_{\{ a ( t ) p ( t ) {f}^{u} ( t ) {f}^{s} ( t ) π ( t ) \}} {lim}_{T \to + ∞} \frac{1}{T} {\sum }_{t = 0}^{T - 1} {E}^{total} ( t ) .$$

In step 105, multiple decision constraint conditions are constructed based on the offloading decision parameter, the actual computing capability, a queue dynamic evolution state, a queue task discard amount, a data transmission power, and a decoding ordering variable.

In an embodiment, before the step 105, the method includes the following steps.

A user dynamic evolution state of a user terminal queue is calculated based on the transmitted data amount, the time-slot computing task amount, and a time-slot task arrival amount.

A user task discard amount of the user terminal queue is calculated based on the user dynamic evolution state, the time-slot task arrival amount, and a user queue upper limit value.

A satellite dynamic evolution state of a satellite queue is calculated based on the transmitted data amount and the time-slot computing task amount.

A satellite task discard amount of the satellite queue is calculated based on the satellite dynamic evolution state, the transmitted data amount, and a satellite queue upper limit value.

The user dynamic evolution state and the satellite dynamic evolution state constitute the queue dynamic evolution state.

The user task discard amount and the satellite task discard amount constitute the queue task discard amount.

It should be noted that to construct the optimization model, corresponding decision constraint conditions need to be configured for the average energy consumption objective function to meet the requirements of joint optimization. Joint optimization needs to consider factors such as offloading strategies, decoding strategies, transmission power allocation, and computing resources. Therefore, to simultaneously ensure long-term task queue stability, improve computing efficiency, and reduce system energy consumption, it is necessary to construct the decision constraint conditions based on multiple parameters including the offloading decision parameter, the actual computing capabilities, the queue dynamic evolution state, the queue task discard amount, the data transmission power, and the decoding ordering variable.

Among these many factors, the queue dynamic evolution state and the queue task discard amount can reflect the state of the system queues. Configuring the decision constraint conditions with queue parameters allows the system optimization model to consider both queue stability and system energy consumption issues simultaneously. By solving the model, a better balance between the two can be achieved, reaching an optimal state.

Both the user terminal and the LEO satellite are equipped with task queues to store arriving computing tasks and track their dynamic states. The user-side task queue is mainly used to store randomly generated computing tasks in each time slot. The computing tasks generated by the user at the beginning of each time slot, arriving at the task queue, need to satisfy independent and identically distributed (i. i. d) with bounded second-order moments, and their distribution must satisfy as follows:

$$E \{ {( {λ}_{n , i}^{u} ( t ) )}^{2} \} = {λ}_{n , i} < ∞ .$$

The user task queue is expressed as

$${Q}_{n}^{u} ( t ) = \{ {Q}_{n , i}^{u} ( t ) \} ,$$

where the user dynamic evolution state of the user terminal U_{n,i} is expressed as follows:

$${Q}_{n , i}^{u} ( t + 1 ) = max \{ {Q}_{n , i}^{u} ( t ) + {λ}_{n , i}^{u} ( t ) - {D}_{n , i}^{u} ( t ) , 0 \} ;$$

where

$${λ}_{n , i}^{u} ( t )$$

represents a time-slot task arrival amount per time slot,

$${D}_{n , i}^{u} ( t )$$

represents an output task amount of the queue of the user terminal U_{n,i},

$${D}_{n , i}^{u} ( t )$$

mainly includes two parts, the local user computing task amount

$${D}_{n , i}^{u , comp} ( t )$$

and the transmitted data amount

$${D}_{n , i}^{u , tran} ( t )$$

offloaded to the LEO satellite; therefore, it can obtain the following formula:

$${D}_{n , i}^{u} ( t ) = {D}_{n , i}^{u , tran} ( t ) + {D}_{n , i}^{u , comp} ( t ) .$$

An upper limit of the user queue for the user terminal U_{n,i} is recorded as

$${Q}_{n , i}^{u , max} ,$$

tasks exceeding the queue upper limit will be discarded, so the user task discard amount is expressed as follows:

$${D}_{n , i}^{u , drop} ( t ) = max \{ {Q}_{n , i}^{u} ( t ) + {λ}_{n , i}^{u} ( t ) - {Q}_{n , i}^{u , max} ( t ) , 0 \} \leq {δ}_{th}^{u} ;$$

where

$${δ}_{th}^{u}$$

represents a maximum task discard tolerance for the user terminal U_{n,i}.

The satellite-side assigns a managed task queue to each user terminal, which can also be called a satellite task queue, specifically represented as

$${Q}_{n}^{s} ( t ) = \{ {Q}_{n , i}^{s} ( t ) \} .$$

Then, an evolution state of the satellite queue managed by the LEO satellite for the user terminal U_{n,i}, that is, the satellite dynamic evolution state, is expressed as follows:

$${Q}_{n , i}^{s} ( t + 1 ) = max \{ {Q}_{n , i}^{s} ( t ) + {D}_{n , i}^{u , tran} ( t ) - {D}_{n , i}^{s} ( t ) , 0 \} ;$$

where

$${D}_{n , i}^{u , tran} ( t )$$

represents an information amount sent by the user terminal U_{n,i}, that is, the transmission data amount, the output task amount is the satellite computing task amount

$${D}_{n , i}^{s , c o m p} ( t )$$

of the satellite task queue. Therefore, it can be seen that

$${D}_{n , i}^{s} ( t ) = {D}_{n , i}^{s , c o m p} ( t ) .$$

An upper limit of the satellite queue managed by the LEO satellite is

$${Q}_{n , i}^{s , max} ,$$

and tasks exceeding this limit are discarded, so the satellite task discard amount is expressed as follows:

$${D}_{n , i}^{s , d r o p} ( t ) = max \{ {Q}_{n , i}^{s} ( t ) + {D}_{n , i}^{u , tran} ( t ) - {D}_{n , i}^{s , max} , 0 \} \leq {δ}_{th}^{s} ;$$

where

$${δ}_{th}^{s}$$

represents a maximum task discard tolerance of the LEO satellite.

After the above calculations, the decision constraint conditions can be constructed based on multiple parameters including the offloading decision parameter, the actual computing capabilities, the queue dynamic evolution state, the queue task discard amount, the data transmission power, and the decoding ordering variable. Specifically, it is necessary to restrict the offloading decision parameter to be a binary variable of 0/1; the actual computing capabilities allocated on the user-side and the satellite-side must not exceed their maximum computing capabilities; the allocated data transmission power must also not exceed its maximum power value; and the decoding ordering variable needs to be in discrete form.

The constraint conditions constructed based on the queue dynamic evolution state and the queue task discard amount are mainly to ensure strong queue stability and that the packet loss amount is not too large. Specifically, limiting a queue length from growing indefinitely based on the user and satellite queue dynamic evolution states ensures that each received data packet is processed within a finite queuing delay, thereby achieving long-term stability of the data queues. This queue stability not only ensures that the backlog of each task queue always remains within a finite range, thereby avoiding exceeding its specified capacity, but also ensures that tasks are processed within a finite time, thereby meeting the system's quality of service (QoS) requirements. The packet loss data amount can be limited not to exceed a specified threshold based on the queue task discard amount.

In step 106, an initial queue energy consumption optimization model is constructed by combining the average energy consumption objective function and the multiple decision constraint conditions, and the initial queue energy consumption optimization model is simplified by using a Lyapunov algorithm to obtain a target optimization model.

In an embodiment, the step 106 includes the following steps.

The initial queue energy consumption optimization model is constructed by combining the average energy consumption objective function and the multiple decision constraint conditions.

A virtual packet loss queue is defined based on the queue task discard amount.

A Lyapunov function is defined by using the Lyapunov algorithm and based on the virtual packet loss queue and the queue dynamic evolution state.

A drift-plus-penalty term is defined based on the Lyapunov function, the time-slot total energy consumption, and an energy consumption weight parameter.

A minimization optimization is performed on the drift-plus-penalty term through a defined queue stability cost function, and the initial queue energy consumption optimization model is simplified to the target optimization model.

Combined with the above configuration of the average energy consumption objective function and the decision constraint conditions, the initial queue energy consumption optimization model can be determined as expressed as follows:

$${min}_{\{ a ( t ) p ( t ) {f}^{u} ( t ) {f}^{s} ( t ) π ( t ) \}} {lim}_{T \to + ∞} \frac{1}{T} {\sum }_{t = 0}^{T - 1} {E}^{total} ( t ) ;$$

$$s . t . C 1 : {lim}_{T \to + ∞} \frac{1}{T} {\sum }_{t = 0}^{T - 1} {\sum }_{n = 1}^{N} {\sum }_{i = 1}^{{I}_{n}} E ( {Q}_{n , i}^{u} ( t ) ) < ∞ ;$$

$$C 2 : {lim}_{T \to + ∞} \frac{1}{T} {\sum }_{t = 0}^{T - 1} {\sum }_{n = 1}^{N} {\sum }_{i = 1}^{{I}_{n}} E ( {Q}_{n , i}^{S} ( t ) ) < ∞ ;$$

$$C 3 : {lim}_{T \to + ∞} \frac{1}{T} {\sum }_{t = 0}^{T - 1} {D}_{n , i}^{u , drop} ( t ) < {δ}_{th}^{u} ∀ n , i ;$$

$$C 4 : {lim}_{T \to + ∞} \frac{1}{T} {\sum }_{t = 0}^{T - 1} {D}_{n , i}^{s , d r o p} ( t ) < {δ}_{th}^{s} ∀ n , i ;$$

$$C 5 : 0 \leq {f}_{n , i}^{u} ( t ) \leq {f}_{n , i}^{u ,} ∀ n , i ;$$

$$C 6 : 0 \leq {f}_{n , i}^{s} ( t ) {\sum }_{n = 1}^{N} {\sum }_{i = 1}^{{I}_{n}} {f}_{n , i}^{s} ( t ) \leq {f}_{n , i}^{s , max} ∀ n , i ;$$

$$C 7 : 0 \leq {p}_{n , i , j} ( t ) {\sum }_{j = 1}^{J} {p}_{n , i , j} ( t ) \leq {p}_{n , i}^{max} ∀ n , i ;$$

$$C 8 : {α}_{n , i} ( t ) ∈ \{ 0 , 1 \} ∀ n , i ;$$

$$C 9 : {π}_{n , i , j} ( t ) ∈ \{ 1 , 2 , … , {I}_{n} J \} ∀ n , i , j ;$$

where

$${p}_{n , i}^{max}$$

represents a maximum value of allocatable data transmission power.

Since the initial queue energy consumption optimization model includes binary variables and continuous variables, it is a long-term stochastic mixed-integer nonlinear programming problem. Moreover, influenced by the dynamic and random nature of the environment, this model problem becomes even more complex and difficult to solve. Therefore, the embodiment proposes to simplify the initial queue energy consumption optimization model by using the Lyapunov algorithm, or transform the solving problem of this model into a series of deterministic optimization problems for each time slot, thereby reducing the solving complexity and enabling it to adapt to dynamically changing environments.

It is still divided into local computation by the user terminal and edge computation by the satellite, virtual packet loss queues can be defined based on their respective queue task discard amounts. The user virtual packet loss queue for the user terminal U_{n,i} at the time slot t is expressed as follows:

$${Z}_{n , i}^{u} ( t + 1 ) = max \{ {Z}_{n , i}^{u} ( t ) + {D}_{n , i}^{u , drop} ( t ) - {δ}_{th}^{u} , 0 \} .$$

The satellite virtual packet loss queue at the LEO satellite at time slot t is expressed as follows:

$${Z}_{n , i}^{s} ( t + 1 ) = max \{ {Z}_{n , i}^{s} ( t ) + {D}_{n , i}^{s , d r o p} ( t ) - {δ}_{th}^{s} , 0 \} .$$

These two virtual packet loss queues can be used to enforce packet loss constraints on the user-side and the satellite-side.

The total queue can be expressed as follows:

$$Θ ( t ) = {\{ Θ ( t ) \}}_{n = 1}^{N} .$$

The queue within each terrestrial user terminal group is expressed as follows:

$$Θ ( t ) = \{ {Θ}_{n}^{u} ( t ) , {Θ}_{n}^{s} ( t ) \} .$$

The user-side queue is expressed as follows:

$${Θ}_{n}^{u} ( t ) = \{ {\{ {Q}_{n , i}^{u} ( t ) \}}_{i}^{{I}_{n}} , {\{ {Z}_{n , i}^{u} ( t ) \}}_{i}^{{I}_{n}} \} .$$

The satellite-side queue is expressed as follows:

$${Θ}_{n}^{s} ( t ) = \{ {\{ {Q}_{n , i}^{s} ( t ) \}}_{i}^{{I}_{n}} , {\{ {Z}_{n , i}^{s} ( t ) \}}_{i}^{{I}_{n}} \} .$$

The Lyapunov function can be defined as follows:

$$L ( Θ ( t ) ) = \frac{1}{2} {\sum }_{n = 1}^{N} {\sum }_{i = 1}^{{I}_{n}} [ {( {Q}_{n , i}^{u} ( t ) )}^{2} + {( {Q}_{n , i}^{s} ( t ) )}^{2} + {( {Z}_{n , i}^{u} ( t ) )}^{2} + {( {Z}_{n , i}^{s} ( t ) )}^{2} ] .$$

The conditional Lyapunov drift can be written as follows:

$$Δ L ( Θ ( t ) ) = 𝔼 [ L ( Θ ( t + 1 ) ) - L ( Θ ( t ) ) \vert Θ ( t ) ] .$$

Assuming the current system queue state in the time slot t is Θₙ(t), then the drift is the expected change of the function over one time slot. Thus, the Lyapunov drift ΔL(Θ(t)) is weighted to obtain a drift-plus-penalty term as follows:

$$ΔL ( Θ ( t ) ) {=}^{△} Δ L ( Θ ( t ) ) + V \cdot 𝔼 [ {E}^{total} ( t ) \vert Θ ( t ) ] ;$$

where V>0, and V represents a weight parameter for emphasizing an importance of a system energy consumption, which is recorded as an energy consumption weight parameter, and can be used to control the balance between system energy consumption and queue stability.

An upper bound of a right side of the drift-plus-penalty term can be optimized as follows:

$$Δ L ( Θ ( t ) ) \leq W + E \{ {\sum }_{n = 1}^{N} {\sum }_{i = 1}^{{I}_{n}} {Q}_{n , i}^{u} ( t ) ( {λ}_{n , i}^{u} ( t ) - {D}_{n , i}^{u} ( t ) ) + {Q}_{n , i}^{s} ( t ) ( {D}_{n , i}^{u , drop} ( t ) - {D}_{n , i}^{s} ( t ) ) + {Z}_{n , i}^{u} ( t ) ( {D}_{n , i}^{u , drop} ( t ) - {δ}_{C h}^{u} ) + {Z}_{n , i}^{s} ( t ) ( {D}_{n , i}^{s , d r o p} ( t ) - {δ}_{th}^{s} ) \vert Θ ( t ) \} + V \cdot 𝔼 [ {E}^{total} ( t ) \vert Θ ( t ) ] ;$$

where W represents a constant, and is expressed as follows:

$$W = {\sum }_{n = 1}^{N} {W}_{n} ;$$

$$where {W}_{n} = {W}_{n}^{u} + {W}_{n}^{s} .$$

For the n^{th} user terminal group, the user-side queue constant is expressed as follows:

$${W}_{n}^{u} \geq \frac{1}{2} {\sum }_{i = 1}^{{I}_{n}} E ( {( {λ}_{n , i}^{u} ( t ) - {D}_{n , i}^{u} ( t ) )}^{2} + {( {D}_{n , i}^{u , drop} ( t ) - {δ}_{th}^{u} )}^{2} \vert Θ ( t ) ) .$$

The satellite-side queue constant is expressed as follows:

$${W}_{n}^{s} \geq \frac{1}{2} {\sum }_{i = 1}^{{I}_{n}} {E ( {D}_{n , i}^{u , tran} ( t ) - {D}_{n , i}^{s} ( t ) )}^{2} + {( {D}_{n , i}^{s , d r o p} ( t ) - {δ}_{th}^{s} )}^{2} \vert Θ ( t ) ) .$$

The queue stability cost function is defined as follows:

$$C ( t ) = {\sum }_{n = 1}^{N} [ {C}^{u} ( t ) + {C}^{s} ( t ) ] ;$$

$$where , {C}_{n} ( t ) = {C}_{n}^{u} ( t ) + {C}_{n}^{s} ( t ) .$$

A user-side queue stability cost function is expressed as follows:

$${C}_{n}^{u} ( t ) = {\sum }_{i = 1}^{{I}_{n}} [ {Q}_{n , i}^{u} ( t ) ( {λ}_{n , i}^{u} ( t ) - {D}_{n , i}^{u} ( t ) ) + {Z}_{n , i}^{u} ( t ) ( {D}_{n , i}^{u , drop} ( t ) - {δ}_{th}^{u} ) ] .$$

A satellite-side queue stability cost function is expressed as follows:

$${C}_{n}^{s} ( t ) = {\sum }_{i = 1}^{{I}_{n}} [ {Q}_{n , i}^{s} ( t ) ( {D}_{n , i}^{u , tran} ( t ) - {D}_{n , i}^{s} ( t ) ) + {Z}_{n , i}^{s} ( t ) ( {D}_{n , i}^{s , drop} ( t ) - {δ}_{th}^{s} ) ] .$$

By minimizing the drift-plus-penalty term, system congestion can be effectively controlled and queue states stabilized, thereby reducing the number of tasks waiting in the buffer. This helps maintain lower levels of task backlog and minimizes task delay to the greatest extent. After the above optimization, the solving problem of the initial queue energy consumption optimization model is transformed into solving the following target optimization model:

$${min}_{\{ α ( t ) p ( t ) {f}^{u} ( t ) {f}^{l} ( t ) π ( t ) \}} W + C ( t ) + V \cdot {E}^{total} ( t ) ;$$

$$C 6 : 0 \leq {f}_{n , i}^{s} ( t ) {\sum }_{n = 1}^{N} {\sum }_{i = 1}^{{I}_{n}} {f}_{n , i}^{s} ( t ) \leq {f}_{n , i}^{s , max} ∀ n , i ;$$

$$C 7 : 0 \leq {p}_{n , i , j} ( t ) {\sum }_{j = 1}^{J} {p}_{n , i , j} ( t ) \leq {p}_{n , i}^{max} ∀ n , i ;$$

$$C 9 : {π}_{n , i , j} ( t ) ∈ \{ 1 , 2 , … , {I}_{n} J \} ∀ n , i , j .$$

In order to approach an optimal solution of the initial queue energy consumption optimization model more closely, the model requires more time to satisfy the average energy consumption constraint. At the same time, a larger V value significantly enhances the system's ability to achieve lower average energy consumption. The target optimization model is suitable for dynamic optimization in each time slot, does not require prior knowledge of environmental information, and does not depend on the probability distribution of random events.

In step 107, hierarchical decision solving is performed on the target optimization model based on a Markov decision process and an SCA algorithm to obtain a target resource allocation strategy.

In an embodiment, the step 107 includes the following steps.

The target optimization model is divided into an upper-layer optimization model and a lower-layer optimization model based on a hierarchical reinforcement learning method guided by the Lyapunov algorithm.

A global queue state space, a global queue action space, and a global queue reward function are defined based on the Markov decision process and the upper-layer optimization model to obtain an upper-layer queue stability decision model.

An optimization solution is performed on the upper-layer queue stability decision model by using an extended SCA algorithm to obtain an offloading strategy, a transmission power allocation strategy, and a decoding strategy.

A local queue state space, a local queue action space, and a local queue reward function are defined based on the Markov decision process and the lower-layer optimization model to obtain a lower-layer queue stability decision model.

An optimization solution is performed on the lower-layer queue stability decision model by using a standard SCA algorithm to obtain a computing resource allocation strategy. The computing resource allocation strategy includes a user computing resource allocation strategy and a satellite computing resource allocation strategy.

The target resource allocation strategy includes the offloading strategy, the transmission power allocation strategy, the decoding strategy, and the computing resource allocation strategy.

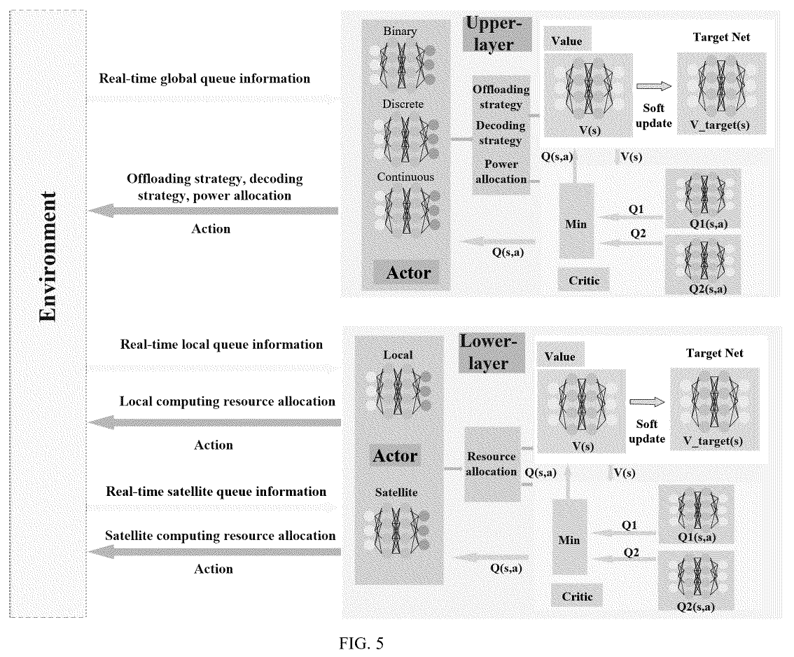

It should be noted that since the target optimization model belongs to complex convex and numerical optimization and cannot be solved directly, the embodiment chooses to model it based on the Markov decision process. Before modeling, in order to consider the coupling between variables and the characteristics of phased optimization, the embodiment combines the Lyapunov-guided hierarchical reinforcement learning method to hierarchically process the target optimization model. Please refer to FIG. 5, the upper-layer optimization model is responsible for optimizing the offloading strategies, the transmission power allocation, and the decoding strategies, while the lower-layer optimization model is responsible for optimizing the computing resource allocation on the user-side and satellite-side.

The Markov decision process can be used to model the upper and lower layers separately. Although Markov decision process modeling includes four basic elements: state, action, state transition probability, and reward, since the solving model in the embodiment does not require prior knowledge of the environment state and does not depend on the probability distribution of random events, the state transition probability is unknown.

Upper-layer decision modeling needs to obtain global queue information, optimize global queue stability by controlling the sending amount from user-side queues to satellite-side queues, and adjust the stability values of queues on both sides. Therefore, the global queue state space can be defined as follows:

$$S ( t ) = \{ {Θ}_{n} ( t ) , {λ}_{n}^{u} ( t ) , {g}_{n , i} ( t ) \} .$$

That is, the global queue state space is composed of the global real-time queue state Θₙ(t), the user task arrival amount

$${λ}_{n}^{u} ( t ) ,$$

and the channel state g_{n,i}(t). The global queue action space can be expressed as follows:

$$A ( t ) = \{ {α}_{n} ( t ) , {π}_{n} ( t ) , {p}_{n} ( t ) \} .$$

That is, the global queue action space is composed of the offloading decision parameter αₙ(t), the decoding ordering variable πₙ(t), and the data transmission power pₙ(t). The global queue reward function can be expressed as follows:

$$R ( t ) = - \{ {w}_{1} {W}_{n} + {w}_{2} {C}_{n} ( t ) + {w}_{3} V \cdot {E}_{n}^{u , tran} ( t ) + {w}_{4} penalty ( t ) \} .$$

where penalty(t) presents a penalty amount for exceeding constraints and violating actions, and w₁, w₂, w₃ and w₄ represent weight coefficients used to balance the magnitudes.

Since the upper-layer action space contains binary data, discrete variables, and continuous variables, the embodiment uses an extended SCA algorithm to solve the constructed Markov model. Specifically, the Bernoulli distribution is used to model and sample binary data to ensure gradients do not vanish. The Gumbel-Softmax technique is used to handle discrete variables, thereby enabling gradient backpropagation for output actions. The reparameterization method is used to handle the continuous variables to ensure gradient continuity during sampling. Finally, the optimal solution for the upper-layer queue stability decision model can be obtained, specifically including the offloading strategy, the transmission power allocation strategy, and the decoding strategy.

Since the lower-layer queue stability decision model optimizes computing resource allocation on the user-side and the satellite-side, its modeling process needs to be divided into user-side modeling and satellite-side modeling. For user-side modeling, the main goal is to obtain user queue information and adjust the computational output of the user queue to optimize queue stability and energy consumption on the user-side. The user-side local queue state space is defined as follows:

$$S ( t ) = \{ {Θ}_{n}^{u} ( t ) , {λ}_{n}^{u} ( t ) \} .$$

That is, the user-side local queue state space is composed of the user-side real-time queue state

$${Θ}_{n}^{u} ( t ) ,$$

and the user task arrival amount

$${λ}_{n}^{u} ( t ) .$$

The user-side local queue action space is defined as follows:

$$A ( t ) = \{ {f}_{n}^{u} ( t ) \} ;$$

where

$${f}_{n}^{u} ( t )$$

represents the user-side computing resource allocation amount.

The user-side local queue reward function is defined as follows:

$$R ( t ) = - \{ {w}_{1} {W}_{n}^{u} + {w}_{2} {C}_{n}^{u} ( t ) + {w}_{3} V \cdot {E}_{n}^{u , comp} ( t ) + {w}_{4} penalty ( t ) \} .$$

Since the user-side action space contains only the continuous variables, the embodiment directly uses the standard SCA algorithm for optimization solving to obtain the user computing resource allocation strategy.

For satellite-side modeling, the main goal is to obtain satellite queue information and adjust the computational output of the satellite queue to optimize queue stability and energy consumption on the satellite-side. Therefore, the satellite-side local queue state space is defined as follows:

$$S ( t ) = \{ {Θ}_{n}^{s} ( t ) , {D}_{n , i}^{u , tran} ( t ) \} .$$

That is, the satellite-side local queue state space is composed of the -side real-time queue state

$${Θ}_{n}^{s} ( t )$$

and the data arrival amount at the satellite

$${D}_{n , i}^{u , tran} ( t ) .$$

The satellite-side local queue action space is defined as follows:

$$A ( t ) = \{ {f}_{n}^{s} ( t ) \} ;$$

where

$${f}_{n}^{s} ( t )$$

represents the satellite-side computing resource allocation amount.

The satellite-side local queue reward function is defined as follows:

$$R ( t ) = - \{ {w}_{1} {W}_{n}^{s} + {w}_{2} {C}_{n}^{s} + {w}_{3} V \cdot {E}_{n}^{s , comp} ( t ) + {w}_{4} penalty ( t ) \} .$$

Similarly, since the satellite-side action space contains only the continuous variables, the standard SCA algorithm is also directly used for optimization solving to obtain the satellite computing resource allocation strategy.

The solution provided in the embodiment can dynamically adjust computing resource allocation based on real-time information to achieve queue stability and energy efficiency on both the user-side and the satellite-side. The system can make dynamic decisions based on real-time information. The lower-layer network optimizes the computational output and energy consumption of queues to achieve queue stability and energy consumption optimization on the user-side and the satellite-side, respectively. The upper-layer network dynamically balances the queue states on both sides by adjusting the transmission amount from user-side queues to satellite-side queues. Through collaborative iterative optimization between the upper and lower layers, the system can gradually converge to a global optimal strategy, thereby achieving efficient operation in complex dynamic environments.

The method for generating the resource allocation strategy based on satellite edge computing provided in the disclosure not only determines whether a computing task should be computed locally or offloaded to the satellite for edge computing based on the offloading decision parameter, but also calculates transmission parameters such as the signal-to-noise ratio for signals transmitted from the user terminal. This process fully considers the heterogeneous characteristics of the user terminals, which makes resource allocation operations based on this more aligned with real-world conditions. Furthermore, by calculating the time-slot total energy consumption resulting from task scheduling while considering various performance parameters of the user terminals and the satellite, and constructing the average energy consumption objective function based on this, the issue of system energy consumption optimization is addressed. Configuring decision constraint conditions based on parameters such as the queue dynamic evolution state and the task discard amount fully considers the queue stability optimization problem. Configuring decision constraint conditions based on the actual computing capabilities, the data transmission power, and the decoding ordering variables takes into account the time-varying characteristics of dynamic communication link changes and resource allocation. Moreover, the process of optimizing and subsequently solving the model by using the Lyapunov algorithm ensures that each optimization objective reaches its optimal solution while also adapting to various data formats within the target optimization model. It can also perform optimization solving for multi-stage optimization problems involving dynamically changing link states and resource allocation, adapting to complex scenario changes. The entire process comprehensively considers multiple situations, various parameters, and the interactions among multiple optimization objectives within the edge computing system, thereby enabling the generation of accurate and reliable resource allocation strategies with strong applicability. Therefore, the disclosure can solve the technical problem in the related art where actual resource allocation lacks accuracy, reliability, and applicability due to the failure to comprehensively consider factors such as task scheduling, resource allocation, communication link status, user heterogeneity, and multiple system performance indicators.

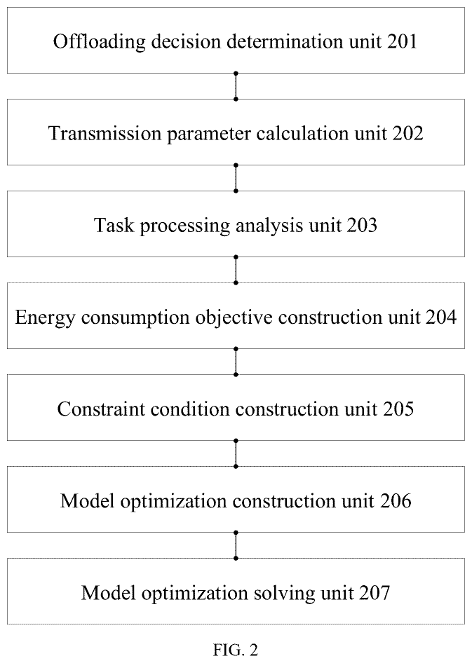

For ease of understanding, please refer to FIG. 2, the disclosure provides an embodiment of an apparatus for generating a resource allocation strategy based on satellite edge computing. The apparatus for generating the resource allocation strategy based on satellite edge computing is applied to a satellite-terrestrial hybrid edge computing system and includes an offloading decision determination unit 201, a transmission parameter calculation unit 202, a task processing analysis unit 203, an energy consumption objective construction unit 204, a constraint condition construction unit 205, a model optimization construction unit 206, and a model optimization solving unit 207.

The offloading decision determination unit 201 is configured to determine, based on a communication resource allocation strategy and a task offloading strategy, a decision for a computing task of each user terminal to obtain an offloading decision parameter.

The transmission parameter calculation unit 202 is configured to calculate, based on the offloading decision parameter, a signal-to-noise ratio, a decoding rate, a transmitted data amount, and a data transmission energy consumption for signal transmission between a satellite and each user terminal.

The task processing analysis unit 203 is configured to calculate, based on the offloading decision parameter and an actual computing capability, a time-slot computing task amount and a time-slot computing energy consumption for each user terminal and the satellite individually, wherein the actual computing capability comprises a user computing capability and a satellite computing capability.

The energy consumption objective construction unit 204 is configured to calculate, based on the data transmission energy consumption and the time-slot computing energy consumption, a time-slot total energy consumption, and to construct, based on the time-slot total energy consumption, an average energy consumption objective function.

The constraint condition construction unit 205 is configured to construct, based on the offloading decision parameter, the actual computing capability, a queue dynamic evolution state, a queue task discard amount, a data transmission power, and a decoding ordering variable, multiple decision constraint conditions.

The model optimization construction unit 206 is configured to construct an initial queue energy consumption optimization model by combining the average energy consumption objective function and the multiple decision constraint conditions, and simplify, by using a Lyapunov algorithm, the initial queue energy consumption optimization model to obtain a target optimization model.

The model optimization solving unit 207 is configured to perform, based on a Markov decision process and an SCA algorithm, hierarchical decision solving on the target optimization model to obtain a target resource allocation strategy.

It is understandable that the specific operation processes of the described apparatus and units can refer to the corresponding processes in the foregoing method embodiments and will not be repeated here.

The disclosure further provides a device for generating a resource allocation strategy based on satellite edge computing, and the device includes a processor and a memory.

The memory is configured to store program codes and transmit the program codes to the processor.

The processor is configured to execute, based on instructions in the program codes, the method for generating the resource allocation strategy based on satellite edge computing as described in the above method embodiment.

In the embodiments provided in the disclosure, it should be understood that the disclosed apparatus and method may be implemented in other ways. For example, the apparatus embodiments described above are only illustrative. For example, the division of units is only a division of logical functions. In actual implementation, there may be other division methods. For example, multiple units or components may be combined or integrated into another system, or some features may be ignored or not executed. Additionally, the mutual coupling or direct coupling or communication connections shown or discussed may be indirect coupling or communication connections through some interfaces, apparatuses, or units, and may be electrical, mechanical, or in other forms.

The units described as separate components may or may not be physically separated. The components displayed as units may or may not be physical units; that is, they may be located in one place or distributed across multiple network units. Some or all of the units may be selected according to actual needs to achieve the objectives of the embodiments.

Furthermore, the functional units in the various embodiments of the disclosure may be integrated into one processing unit, or each unit may exist physically alone, or two or more units may be integrated into one unit. The above integrated units can be implemented in the form of hardware or software functional units.

If the integrated unit is implemented in the form of a software functional unit and sold or used as an independent product, it may be stored in a computer-readable storage medium. Based on this understanding, the technical solution of the disclosure essentially, or the part contributing to the related art, or all or part of the technical solution, may be embodied in the form of a software product. The computer software product is stored in a storage medium and includes instructions for causing a computer device (which may be a personal computer, a server, or a network device) to perform all or part of the steps of the methods described in the various embodiments of the disclosure. The aforementioned storage medium includes: U disk, mobile hard disk, read-only memory (ROM), random access memory (RAM), magnetic disk, or optical disk, and other media that can store program code.

The above description is only specific embodiments of the disclosure, but the scope of protection of the disclosure is not limited thereto. Any those skilled in the art can easily think of changes or substitutions within the technical scope disclosed in the disclosure, which should be covered within the scope of protection of the disclosure. Therefore, the scope of protection of the disclosure shall be subject to the scope of protection of the claims.

1. A method for generating a resource allocation strategy based on satellite edge computing, applied to a satellite-terrestrial hybrid edge computing system, wherein the method comprises:
determining, based on a communication resource allocation strategy and a task offloading strategy, a decision for a computing task of each of user terminals to obtain an offloading decision parameter;
calculating, based on the offloading decision parameter, a signal-to-noise ratio, a decoding rate, a transmitted data amount, and a data transmission energy consumption for signal transmission between a satellite and each of the user terminals;
calculating, based on the offloading decision parameter and an actual computing capability, a time-slot computing task amount and a time-slot computing energy consumption for each of the user terminals and the satellite individually, wherein the actual computing capability comprises a user computing capability and a satellite computing capability;
calculating, based on the data transmission energy consumption and the time-slot computing energy consumption, a time-slot total energy consumption, and constructing, based on the time-slot total energy consumption, an average energy consumption objective function;
constructing, based on the offloading decision parameter, the actual computing capability, a queue dynamic evolution state, a queue task discard amount, a data transmission power, and a decoding ordering variable, a plurality of decision constraint conditions;
constructing an initial queue energy consumption optimization model by combining the average energy consumption objective function and the plurality of decision constraint conditions, and simplifying, by using a Lyapunov algorithm, the initial queue energy consumption optimization model to obtain a target optimization model, wherein the target optimization model is expressed as follows:
$${min}_{\{ α ( t ) p ( t ) {f}^{u} ( t ) {f}^{l} ( t ) π ( t ) \}} W + C ( t ) + V \cdot {E}^{total} ( t ) ;$$
$$0 \leq {f}_{n , i}^{u} ( t ) \leq {f}_{n , i}^{u , max} ∀ n , i ; \qquad C5$$
$$0 \leq {f}_{n , i}^{s} ( t ) {\sum }_{n = 1}^{n} {\sum }_{i = 1}^{{I}_{n}} {f}_{n , i}^{s} ( t ) \leq {f}_{n , i}^{s , max} ∀ n , i ; \qquad C6$$
$$0 \leq {p}_{n , i , j} ( t ) {\sum }_{j = 1}^{J} {p}_{n , i , j} ( t ) \leq {p}_{n , i}^{max} ∀ n , i ; \qquad C7$$
$${α}_{n , i} ( t ) ∈ \{ 0 , 1 \} ∀ n , i ; \qquad C8$$
$${π}_{n , i , j} ∈ \{ 1 , 2 , … , {I}_{n} J \} ∀ n , i , j ; \qquad C9$$
wherein W represents a constant, C(t) represents a queue stability cost, V>0, and V represents a weight parameter for emphasizing an importance of a system energy consumption, E^{total}(t) represents a time-slot total energy consumption of the satellite-terrestrial hybrid edge computing system at a time slot t,
$${f}_{n , i}^{u} ( t )$$
represents an amount of computing resources allocated to a user terminal U_{n,i}, the user terminal U_{n,i} is an i^{th} user terminal in a n^{th} terrestrial user terminal group on a user-side,
$${f}_{n , i}^{u , max}$$
represents a maximum allocatable computing resource amount for the user terminal U_{n,i},
$${f}_{n , i}^{s} ( t )$$
represents computing resources allocated to the user terminal U_{n,i} at the satellite,
$${f}_{n , i}^{s , max}$$
represents a maximum allocatable computing resource amount at the satellite, p_{n,i,j}(t) represents a data transmission power allocated by the user terminal U_{n,i} to a message flow j,
$${p}_{n , i}^{max}$$
represents a maximum value of an allocatable data transmission power, α_{n,i}(t) represents an offloading decision parameter for the i^{th} user terminal in the n^{th} terrestrial user terminal group, π_{n,i,j}(t) represents a decoding ordering variable for the message flow j allocated by the user terminal U_{n,i}, N represents a total number of terrestrial user terminal groups, Iₙ represents a total number of the user terminals, and J represents a total number of allocated message flows; and
performing, based on a Markov decision process and a successive convex approximation (SCA) algorithm, hierarchical decision solving on the target optimization model to obtain a target resource allocation strategy.

2. The method as claimed in claim 1, wherein before the determining, based on a communication resource allocation strategy and a task offloading strategy, a decision for a computing task of each of user terminals to obtain an offloading decision parameter, the method further comprises:
formulating, based on mobility of the user terminals, a task demand amount, and a link state, the communication resource allocation strategy, the task offloading strategy, and a computing resource allocation strategy dynamically.

3. The method as claimed in claim 1, wherein the calculating, based on the offloading decision parameter, a signal-to-noise ratio, a decoding rate, a transmitted data amount, and a data transmission energy consumption for signal transmission between a satellite and each of the user terminals comprises:
calculating, based on the offloading decision parameter, a channel model and the data transmission power, a signal-to-noise ratio for each signal transmitted from each of the user terminals to the satellite;
calculating, based on the signal-to-noise ratio and a total system bandwidth, the decoding rate for each of the message flows;
calculating, based on the decoding rate and a task transmission time, the transmitted data amount for each of the message flows; and
calculating a time-slot transmission energy consumption of each of the user terminals by combining the offloading decision parameter and the data transmission power to obtain the data transmission energy consumption.

4. The method as claimed in claim 1, wherein the calculating, based on the offloading decision parameter, a signal-to-noise ratio, a decoding rate, a transmitted data amount, and a data transmission energy consumption for signal transmission between a satellite and each of the user terminals further comprises:
transmitting, by using a rate-splitting multiple access (RSMA) technology and based on the transmitted data amount and the data transmission energy consumption, the message flows of the user terminals to the satellite for computation; and
decoding the message flows and allocating the computing resources by the satellite and based on a successive interference cancellation (SIC) technology and a computing resource allocation strategy.

5. The method as claimed in claim 1, wherein the calculating, based on the offloading decision parameter and an actual computing capability, a time-slot computing task amount and a time-slot computing energy consumption for each of the user terminals and the satellite individually comprises:
calculating, based on the offloading decision parameter and the user computing capability, a computing task amount of each the user terminals to obtain a user computing task amount;
calculating, based on the offloading decision parameter, the user computing capability and a transmission computing time, a computing energy consumption of each of the user terminals to obtain a user computing energy consumption;
calculating, based on the satellite computing capability and a satellite processing density, a computing task amount of the satellite to obtain a satellite computing task amount; and
calculating, based on the satellite computing capability and a satellite computing time, a computing energy consumption of the satellite to obtain a satellite computing energy consumption;
wherein the user computing task amount and the satellite computing task amount constitute the time-slot computing task amount; and
wherein the user computing energy consumption and the satellite computing energy consumption constitute the time-slot computing energy consumption.

6. The method as claimed in claim 1, wherein before the constructing, based on the offloading decision parameter, the actual computing capability, a queue dynamic evolution state, a queue task discard amount, a data transmission power, and a decoding ordering variable, a plurality of decision constraint conditions, the method further comprises:
calculating, based on the transmitted data amount, the time-slot computing task amount, and a time-slot task arrival amount, a user dynamic evolution state of a user terminal queue;
calculating, based on the user dynamic evolution state, the time-slot task arrival amount and a user queue upper limit value, a user task discard amount of the user terminal queue;
calculating, based on the transmitted data amount and the time-slot computing task amount, a satellite dynamic evolution state of a satellite queue; and
calculating, based on the satellite dynamic evolution state, the transmitted data amount, and a satellite queue upper limit value, a satellite task discard amount of the satellite queue;
wherein the user dynamic evolution state and the satellite dynamic evolution state constitute the queue dynamic evolution state; and
wherein the user task discard amount and the satellite task discard amount constitute the queue task discard amount.

7. The method as claimed in claim 1, wherein the constructing an initial queue energy consumption optimization model by combining the average energy consumption objective function and the plurality of decision constraint conditions, and simplifying, by using a Lyapunov algorithm, the initial queue energy consumption optimization model to obtain a target optimization model comprises:
constructing the initial queue energy consumption optimization model by combining the average energy consumption objective function and the plurality of decision constraint conditions;
defining, based on the queue task discard amount, a virtual packet loss queue;
defining, by using the Lyapunov algorithm and based on the virtual packet loss queue and the queue dynamic evolution state, a Lyapunov function;
defining, based on the Lyapunov function, the time-slot total energy consumption, and an energy consumption weight parameter, a drift-plus-penalty term; and
performing a minimization optimization on the drift-plus-penalty term through a defined queue stability cost function, and simplifying the initial queue energy consumption optimization model to the target optimization model.

8. The method as claimed in claim 1, wherein the performing, based on a Markov decision process and an SCA algorithm, hierarchical decision solving on the target optimization model to obtain a target resource allocation strategy comprises:
dividing, based on a hierarchical reinforcement learning method guided by the Lyapunov algorithm, the target optimization model into an upper-layer optimization model and a lower-layer optimization model;
defining, based on the Markov decision process and the upper-layer optimization model, a global queue state space, a global queue action space, and a global queue reward function to obtain an upper-layer queue stability decision model;
performing, by using an extended SCA algorithm, an optimization solution on the upper-layer queue stability decision model to obtain an offloading strategy, a transmission power allocation strategy, and a decoding strategy;
defining, based on the Markov decision process and the lower-layer optimization model, a local queue state space, a local queue action space, and a local queue reward function to obtain a lower-layer queue stability decision model; and
performing, by using a standard SCA algorithm, an optimization solution on the lower-layer queue stability decision model to obtain a computing resource allocation strategy, wherein the computing resource allocation strategy comprises a user computing resource allocation strategy and a satellite computing resource allocation strategy; and
wherein the target resource allocation strategy comprises the offloading strategy, the transmission power allocation strategy, the decoding strategy, and the computing resource allocation strategy.

9. An apparatus for generating a resource allocation strategy based on satellite edge computing, applied to a satellite-terrestrial hybrid edge computing system, wherein the apparatus comprises:
an offloading decision determination unit, configured to determine, based on a communication resource allocation strategy and a task offloading strategy, a decision for a computing task of each of user terminals to obtain an offloading decision parameter;
a transmission parameter calculation unit, configured to calculate, based on the offloading decision parameter, a signal-to-noise ratio, a decoding rate, a transmitted data amount, and a data transmission energy consumption for signal transmission between a satellite and each of the user terminals;
a task processing analysis unit, configured to calculate, based on the offloading decision parameter and an actual computing capability, a time-slot computing task amount and a time-slot computing energy consumption for each of the user terminals and the satellite individually, wherein the actual computing capability comprises a user computing capability and a satellite computing capability;
an energy consumption objective construction unit, configured to calculate, based on the data transmission energy consumption and the time-slot computing energy consumption, a time-slot total energy consumption, and to construct, based on the time-slot total energy consumption, an average energy consumption objective function;
a constraint condition construction unit, configured to construct, based on the offloading decision parameter, the actual computing capability, a queue dynamic evolution state, a queue task discard amount, a data transmission power, and a decoding ordering variable, a plurality of decision constraint conditions;
a model optimization construction unit, configured to construct an initial queue energy consumption optimization model by combining the average energy consumption objective function and the plurality of decision constraint conditions, and simplify, by using a Lyapunov algorithm, the initial queue energy consumption optimization model to obtain a target optimization model, wherein the target optimization model is expressed as follows:
$${min}_{\{ α ( t ) p ( t ) {f}^{u} ( t ) {f}^{l} ( t ) π ( t ) \}} W + C ( t ) + V \cdot {E}^{total} ( t ) ;$$
$$0 \leq {f}_{n , i}^{u} ( t ) \leq {f}_{n , i}^{u , max} ∀ n , i ; \qquad C5$$
$$0 \leq {f}_{n , i}^{s} ( t ) {\sum }_{n = 1}^{n} {\sum }_{i = 1}^{{I}_{n}} {f}_{n , i}^{s} ( t ) \leq {f}_{n , i}^{s , max} ∀ n , i ; \qquad C6$$
$$0 \leq {p}_{n , i , j} ( t ) {\sum }_{j = 1}^{J} {p}_{n , i , j} ( t ) \leq {p}_{n , i}^{max} ∀ n , i ; \qquad C7$$
$${α}_{n , i} ( t ) ∈ \{ 0 , 1 \} ∀ n , i ; \qquad C8$$
$${π}_{n , i , j} ∈ \{ 1 , 2 , … , {I}_{n} J \} ∀ n , i , j ; \qquad C9$$
wherein W represents a constant, C(t) represents a queue stability cost, V>0, and represents a weight parameter for emphasizing an importance of a system energy consumption, E^{total}(t) represents a time-slot total energy consumption of the satellite-terrestrial hybrid edge computing system at a time slot t,
$${f}_{n , i}^{u} ( t )$$
represents an amount of computing resources allocated to a user terminal U_{n,i}, the user terminal U_{n,i} is an i^{th} user terminal in a n^{th} terrestrial user terminal group on a user-side,
$${f}_{n , i}^{u , max}$$
represents a maximum allocatable computing resource amount for the user terminal U_{n,i},
$${f}_{n , i}^{s} ( t )$$
represents computing resources allocated to the user terminal U_{n,i} at the satellite,
$${f}_{n , i}^{u , max}$$
represents a maximum allocatable computing resource amount at the satellite, p_{n,i,j}(t) represents a data transmission power allocated by the user terminal U_{n,i} to a message flow j,
$${p}_{n , i}^{max}$$
represents a maximum value of an allocatable data transmission power, α_{n,i}(t) represents an offloading decision parameter for the i^{th} user terminal in the n^{th} terrestrial user terminal group, π_{n,i,j}(t) represents a decoding ordering variable for the message flow j allocated by the user terminal U_{n,i}, N represents a total number of terrestrial user terminal groups, Iₙ represents a total number of the user terminals, and J represents a total number of allocated message flows; and
a model optimization solving unit, configured to perform, based on a Markov decision process and an SCA algorithm, hierarchical decision solving on the target optimization model to obtain a target resource allocation strategy.

10. A device for generating a resource allocation strategy based on satellite edge computing, comprising a processor and a memory;
wherein the memory is configured to store program codes and transmit the program codes to the processor; and
wherein the processor is configured to execute, based on instructions in the program codes, the method for generating the resource allocation strategy based on satellite edge computing as claimed in any one of claims 1-8.
